(19) United States
(12) Patent Application Publication
(10) Pub. No.: US 2010/0195679 A1
(43) Pub. Date: Aug. 5, 2010

(54) Solid-state laser comprising a resonator with a monolithic structure

(76) Inventors: Gerhard Kroupa, Villach (AT); Georg Franz, Villach (AT); Ernst Winklhofer, St. Johann (AT); Roman Leitner, Graz (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 12/308,250

(22) PCT Filed: Jun. 13, 2007
(86) PCT No.: PCT/AT2007/000287

§ 371 Date: Dec. 15, 2008

(51) Int. Cl. H01S 3/11; H01S 3/0941; H01S 3/06; H01S 3/042

(52) U.S. Cl. 372/10; 372/75; 372/35

(57) ABSTRACT

The invention relates to a solid-state laser, comprising a resonator (1) with a monolithic structure consisting of a laser medium, on which a passive Q-switch (12) and at least one resonator mirror are directly formed, and comprising several laser diodes (22) which, as a pump medium, radiate into the resonator (1) from the side. A simple and robust configuration with simultaneous high efficiency is achieved in such a way that the monolithic resonator (1) is held at one end in a first holding plate (31) and is held at its other end in a second holding plate (32), and between the first and second holding plate (31, 32) at least one carrier ring (21) is mounted which carries several laser diodes (22) which are passively wavelength stabilized.

The invention relates to a solid-state laser, comprising a resonator with a monolithic structure consisting of a laser medium, on which a passive Q-switch and at least one resonator mirror are formed, and comprising several laser diodes which, as a pump medium, radiate into the resonator from the side.

Most available lasers of high output are designed for stationary applications. As a result, size and weight are rarely a major problem, as are power consumption and efficiency. The location of the generation of laser light and the place of application of laser energy are often spatially separated and only connected with each other by fiber-optic waveguides. This leads to the advantage that the actual laser light source, irrespective of the application, can be operated under controlled ambient conditions which are optimized for the operation of the laser.

A number of applications have been developed in the past years for which mobile laser light sources would have been required or at least advantageous. Such applications range from laser-based marking systems over the ignition of fuel/air mixtures by means of lasers up to chemico-physical analytic systems such as laser-induced plasma spectroscopy (LIPS, LIBS) or targeted laser ablation. For such applications, laser light sources of compact design and/or the lowest possible need for energy with high output simultaneously are required. Moreover, it should be possible to operate these laser light sources directly on site, under ambient conditions that under certain circumstances may not be optimal for laser operation such as mechanical vibrations and/or increased or changing temperatures. Established and commercially available laser designs usually do not offer useful solutions.

A number of approaches for the construction of compact laser light sources of high output are known from literature. However, they offer partly critical limitations in practical applicability. Critical items are especially efficiency and, in connection with this, the energy requirement and the sturdiness and the ensuing usefulness of the laser under operating conditions.

Up to 90% or more of the introduced energy is converted into heat in solid-state lasers depending on design and operational state and only a small part of this is converted into useful laser energy. Moreover, temperature stabilization of compact lasers generally represents a priority problem in the construction of laser-diode-pumped solid-state lasers because the emission wavelengths of semiconductor laser diodes usually depend significantly on the operating temperature and the emission maximum typically drifts by ˜0.3 nm/K. This represents a problem especially when using solid-state laser media with a narrow absorption band such as neodymium-doped yttrium aluminum garnet (Nd:YAG). For an efficient energy injection it is necessary in this case to stabilize the operating temperature of the semiconductor pump diode to typically <±2 K.

In order to solve this problem, a number of approaches have been published. For example, EP 0 471 707 B1 suggests a tempering by means of gaseous or liquid tempering media by cooling ducts, with the tempering medium being tempered externally. Tempering via tempering media is only viable in operating states that remain approximately the same. In the case of rapid temperature changes, especially as a consequence of load changes in the laser, such systems are too sluggish for practical use. The same applies to the use of systems with integrated heat conducting elements such as are known from WO 2003/030312 A2 for example. It is accordingly proposed for example in DE 42 295 00 A or EP 1 034 584 B1 for example to solve the problem of tempering of a pump laser diode and the laser medium by means of thermoelectric elements, especially by using Peltier elements. Such a pure thermoelectric system can only be applied to tempering within a narrow temperature range. For applications in which one must expect a significant change of the ambient temperature, such tempering systems are quickly overstrained and are thus unsuitable.

An alternative that is principally technically viable is a combination of these two methods, as explained for example in EP 1 519 038 A1 and EP 1 519 039 A1 for the arrangement of a compact laser light source for the ignition of fuel/air mixtures. The complexity of such a tempering system is considerable however. In the cited specifications, temperature stabilization is effected via a multi-step tempering system, consisting of “at least two, preferably three different cooling systems”. Specifically, a combination of circuits of fluid tempering media with Peltier elements is proposed, which entails considerable efforts in respect of construction and control. Moreover, a rapid transfer of considerable heat quantities is required especially in the case of laser applications requiring high outputs, which thus entails the need for a respectively large heat exchanger surface. Especially in the case of compact configurations, this requires a large number of narrow and/or long flow ducts, which adds complexity to the construction and entails a considerable input of energy for circulating the tempering medium. Moreover, the use of thermoelectric components for the tempering entails a high need for energy, which reduces the overall efficiency of the laser light source.

A further problem that occurs especially when a solid-state laser needs to be arranged in an especially compact and sturdy way such as the use as an ignition source in an internal combustion engine or an aircraft turbine is to avoid sources of error in the adjustment of the individual components and to minimize the overall need for adjustment essentially to a minimum. Similarly, reliable operation shall be ensured even under adverse ambient conditions by maximum sturdiness. The disadvantages as described above can also be found in the solutions as have been described for example in EP 0 743 725 A or in WO 02/073322 A.

In order to minimize positional variabilities and the resulting necessity of precise adjustment of the required optical components, it is proposed to use monolithic laser resonators instead of the usual laser resonators of discrete configuration. A monolithic laser resonator shall be understood as being an element in which all required components of a laser resonator are integrated in a single “monolithic” component, i.e. active laser medium and resonator mirror, supplemented optionally by additional elements such as Q-switches. Such elements are known from WO 2004/034523 A2 for example. This integration of all components of a laser resonator in a single component, the monolithic laser resonator, has a number of practical advantages, both with respect to construction and operation of the laser as well as durability of the optical components.

As a result of the integration in a component and the resulting loss of positional variabilities, the number of the fastening elements required for the optical components of the laser resonator is minimized from a constructional standpoint and the adjusting elements can be omitted completely. This subsequently allows the arrangement of compact laser light sources which simultaneously are substantially insensitive to external influences. At the same time, complex adjustment of the individual components in assembly and maintenance is avoided, thus significantly reducing the costs for such laser light sources in comparison with systems arranged in a discrete way.

A second advantage lies in the reduction of boundary surfaces in the optical path of the laser resonator. Especially in the case of lasers with high energy densities as occur in the arrangement in accordance with the invention, any boundary surface represents a potential weak point and a reduction in output. By integrating laser medium, passive Q-switch (“saturable absorber”) and advantageously the resonator mirrors in a single monolithic component, the number of boundary surfaces can be minimized and subsequently the efficiency and the service life of such a laser can be improved considerably in comparison with systems arranged in a discrete manner.

The present invention assumes such a monolithic solid-state layer. Although the problems concerning the amount of adjusting work and the mechanical sturdiness can principally be overcome, the question of a suitable cooling system in connection with the dependency of the emission wavelengths of semiconductor laser diodes on the temperature still needs to be resolved.

It is the object of the present invention to further develop a solid-state laser of the kind mentioned above in such a way that a simple compact and sturdy configuration is achieved, with a substantial independence from external thermal conditions and the load of the solid-state laser being given especially also in the case of a simple cooling system. It is further object in summary to ensure high efficiency of the laser system.

These objects are achieved in accordance with the invention in such a way that the monolithic resonator is held at one end in a first holding plate and is held at its other end in a second holding plate, and between the first and second holding plate at least one carrier ring is mounted which carries several laser diodes which are passively wavelength stabilized.

A first aspect of the present invention is to use passively wavelength-stabilized laser diodes. This ensures at first a higher tolerance range for the temperature of the laser diodes, which ensures that the cooling system can be simplified accordingly. This possibility of simplification is utilized by the special constructional design, so that an especially simple and sturdy configuration is obtained which is especially suitable as an ignition source in jet engines, internal combustion engines or also in mobile LIBS analytic devices.

Passively wavelength-stabilized laser diodes are generally know, such as from Volodin et al.: “Volume stabilization and spectrum narrowing of high power multimode laser diodes and arrays by use of volume bragg gratings” in Optics Letters 2004, Vol. 29, pages 1891ff, or from WO 2005/013439 A.

The use of passively wavelength-stabilized laser diodes as pump light sources for the excitation of the laser medium of a compact laser light source offers a number of practical advantages. Firstly, the use of a passively wavelength-stabilized pump source reduces the problem of thermal drift of the emission maximum of the excitation light source. The thermal drift for a semiconductor laser diode with a holographic grating placed on the emission surface such as a “volume Bragg grating” is typically 0.01 nm/K. It is thus sufficient for practical operation to stabilize the temperature of such laser diodes to typically ±15 K. As a result, an efficient operation of the pump laser is possible even without precise active automatic control of the temperature and/or the diode current, as is common practice and required in active wavelength-stabilized laser diodes. It is thus ensured in comparison with prior known systems to substantially simplify tempering, especially with respect to the required control accuracy.

A further advantage of the extended operating temperature range is the behavior of the laser during a change in load. A change in load such as a change of the pulse rate of the laser principally entails a change of the power loss, thus changing the temperature of the pump diodes, at least temporarily. In prior known systems, this leads to change in the emission wavelength of the pump diode and consequently the laser efficiency. In the case of an inadequately quick compensation by temperature adjustment, one must expect unstable operating states up to the interruption of the laser emission by the solid-state laser. In analogy to this, prior known laser-diode-pumped solid-state lasers usually require a preparation period in order to reach a stable operating state. In contrast to this, solid-state lasers pumped with a passively wavelength-stabilized pump source have a considerably higher operational stability under load changes, place considerably lower requirements on the dynamic control behavior of tempering and can typically be used immediately without any preparation period.

It is thus possible, by using passively wavelength-stabilized pump diodes, to avoid the use of complex, power-consuming, costly and rapidly responding temperature controls. As a result of the significantly reduced temperature influence, both in steady-load permanent operation as well as load-changing operation, a simple, sturdy and cost-effective and comparatively more sluggish tempering with significantly lower demands on the precision of tempering than in prior known systems is sufficient. Depending on the power loss of the laser to be dissipated, an active or passive air cooling or, for higher outputs, a liquid tempering with an external tempering device can be used. Solid-state laser configured according to the described principle can be constructed in a more compact way at comparable output and are more sturdy, reliable, failure-proof and cost-effective in production and operation than comparable prior known systems.

A further advantage in the use of passively wavelength-stabilized pump diodes lies in an increase of the launch efficiency of the pump energy into the laser medium of the solid-state laser. As a result of the external grating, the half-value width of the emission of a semiconductor laser diode decreases typically from 3 nm (FWHM) to typically 1 nm (FWHM). Especially in the case of laser media with a narrow absorption profile such as Nd:YAG with a half-value width of the absorption profile of approximately 1.5 nm, a significant improvement of the launch efficiency can be achieved.

It is overall possible to decisively improve the operational stability of solid-state lasers, increase overall efficiency and minimize the need for cooling by using passively wavelength-stabilized semiconductor laser diodes as a pumping source for solid-state lasers, preferably by using external reflection elements, more preferably on the basis of holographic gratings.

The use of the described elements which are coupled in accordance with the invention, i.e. monolithic laser resonator with integrated passive Q-switch, radial pumping with annularly arranged passively wavelength-stabilized laser diodes as pump light sources and installation in a compact housing which holds the monolithic laser resonator and provides the apparatuses for the principal tempering of the entire laser, which means both the pump light sources as well as the laser medium, subsequently provides the construction of laser light sources with especially advantageous properties through mutual interactions of the components.

The proposed use of passively wavelength-stabilized laser diodes as pump light sources ensures at first a reduction of the influence of the ambient temperature on the function of the laser. This ensures operating the laser with simple cooling over a wide temperature range. This further ensures at first realizing significantly smaller overall sizes than in comparable systems, thus making these laser light sources interesting for practical applications.

The compact overall size thus achieved further ensures achieving a “gain” in the laser medium which is significantly over the values that are commonly achieved for solid-state laser of comparable output. This high gain factor that is caused by the overall size subsequently enables efficient operation of the monolithic laser resonator with integrated saturable absorber used in accordance with the invention (passive Q-switch).

The use of a monolithically arranged laser resonator in accordance with the invention leads to significantly lower losses in the laser medium than in a conventional discrete configuration. This is highly important especially in view of the high gain and the thus resulting high power density in the active laser medium because the tempering of the laser medium too is possible in a simple manner, which forms the precondition for the construction of a compact laser light source with a high gain factor and efficient use of the passively wavelength-stabilized pump laser diodes.

The advantageous nature of the proposed arrangement for constructing compact laser light sources of high output can further be seen from the fact that according to the state of the art, unstable laser emissions should be expected without consideration of the specific interactions of the components for such a laser, at least at low pump rates. Only the interactions as are explained above and resulting from the combination in accordance with the invention of the mentioned features ensure stable operation at high pulse output, even at low pulse frequencies. The arrangement in accordance with the invention thus allows realizing for the first time solid-state lasers with high and/or variable pulse frequency and output with excellent operational stability even in the case of load changing or changing ambient conditions, and high failure safety in compact, cost-effective sizes.

Especially high power densities and/or simple scalability of the laser output can be achieved in such a way that several carrier rings are arranged behind one another. In this way, the entire circumferential surface area of the resonator can be used for injecting radiation.

A further advantage of the use of several carrier rings is that therefore an increase in the frequency of the pump pulses is enabled in a simple way beyond the amount that is maximally possible for a single laser diode. For this purpose, the laser diodes of the various carrier rings are pulsed with respect to each other in a temporally staggered way, as a result of which an entirely high pump pulse frequency at lower pulse frequency and thus a reduced load on the individual pump laser diodes can be achieved.

In order to achieve even illumination of the active laser medium and thus optimal injection of energy, a preferably uneven number of laser diodes are arranged at even distances in each carrier ring. The number of laser diodes should at least be three. As a supplementary measure, it can be ensured by suitable optical measures such as mirroring or the like that a high percentage of the injected light power remains in the resonator and is available for pumping the laser.

Especially efficient cooling can be achieved when cooling ducts are provided which extend through the first and second holding plate and through at least one carrier ring.

In a first especially preferred embodiment of the present invention, a jacket tube is clamped between the first and second holding place, which jacket tube encloses the monolithic resonator. A flow space for a liquid cooling medium is provided between the resonator and the jacket tube. An annular space is thus formed between the resonator and the jacket tube which is flowed through by a liquid cooling medium. Said cooling can be realized on the one hand in the form of a forced circulation. In systems with lower loads however it is also possible to use a merely convective cooling in the manner of a heat pipe. In order to avoid possible losses that occur from the irradiation of the resonator, it is especially preferred when the jacket tube is coated in a reflective way, with the reflector coating having windows in the area of the laser diodes. The reflector coating only has breakthroughs at locations where the laser diodes radiate into the resonator.

An alternative embodiment of the present invention is characterized in that the space between the monolithic resonator and the carrier rings is filled with an insulating cooling medium. This embodiment is especially simple because no jacket tube is required in this case. In order to prevent a short circuit in making contact with the laser diodes, an insulating cooling medium is provided such as liquid perfluoropolyether.

The present invention is now explained below in closer detail by reference to the embodiments shown in the drawings, wherein:

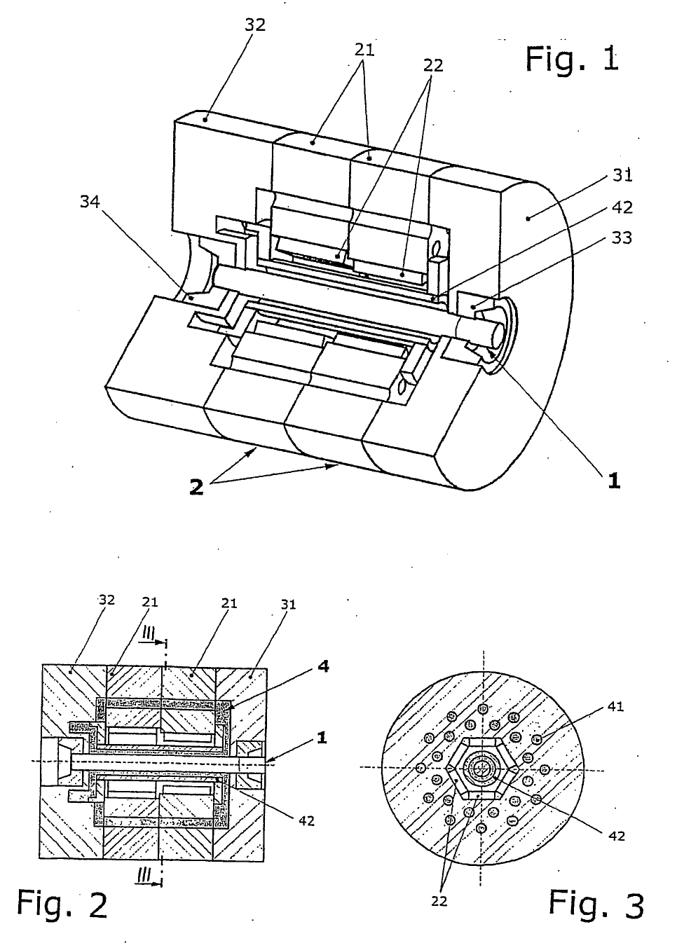

FIG. 1 shows a first embodiment of the present invention in a partly sectional axonometric view;

FIG. 2 shows the embodiment of FIG. 1 in a longitudinal sectional view; FIG. 3 shows a sectional view along line III-III in FIG. 2;

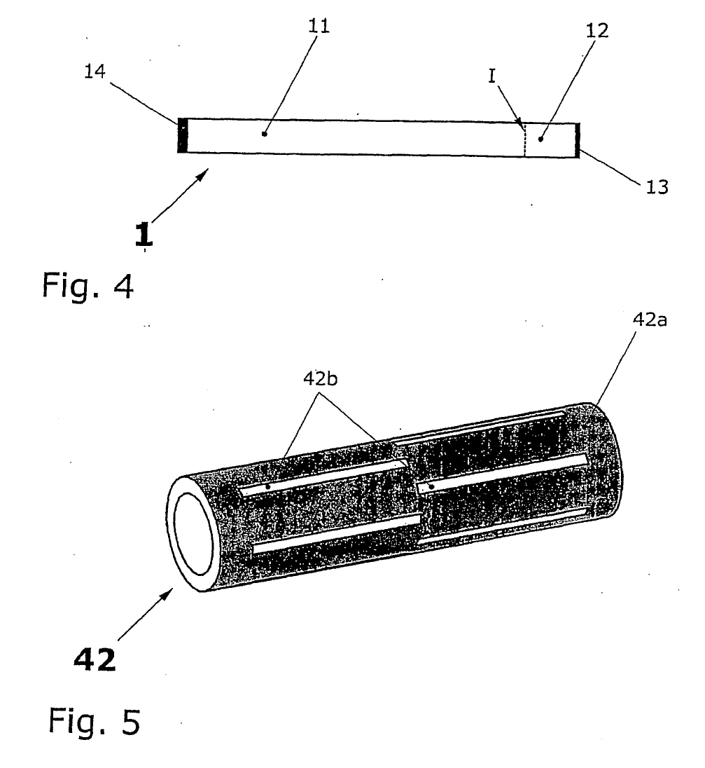

FIG. 4 shows in detail a monolithic laser resonator arranged in accordance with the invention;

FIG. 5 shows a jacket tube according to a preferred embodiment of the invention, and

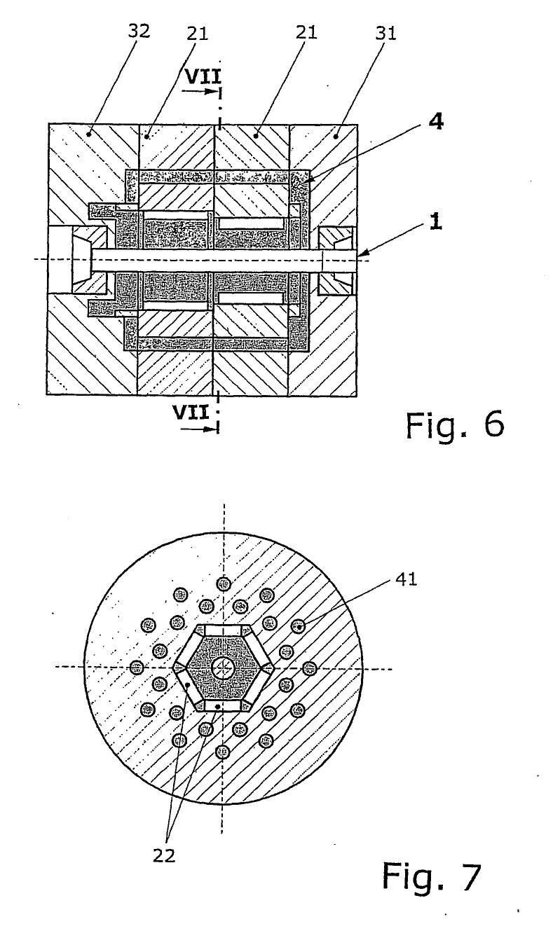

FIG. 6 and FIG. 7 show a further embodiment in the illustration according to FIG. 2 and FIG. 3, with FIG. 7 showing a sectional view along line VII-VII in FIG. 6.

A monolithic laser resonator generally designated with reference numeral 1 is held by means of fastening elements 33, 34 at one end in a first holding plate 31 and at another end in a second holding plate 32. Two carrier rings 21 are mounted between the holding plates 31, 32, which rings each carry several laser diodes 22 on their inner circumference. A jacket tube 42, which is also known as flow tube, encloses the monolithic resonator 1 in order to form a flow space for a cooling medium. Cooling ducts 41 which extend from the first holding plate 31 via the carrier rings 21 up to the second holding plate 32 are in connection with the flow space in order to form a closed cooling system.

As a result of the combination in accordance with the invention of using passively wavelength stabilized laser diodes 22 of high output and a monolithic laser resonator 1, it is possible for the first time and exclusively to generate laser light pulses with a typical pulse power of 30 mJ and a typical pulse duration in the range of 2 to 10 ns with a laser light source with a typical overall size of 40 mm diameter and 70 mm length without an integrated electronic control system or with a typical overall size of 40 mm diameter and 120 mm length with an integrated electronic control system. The laser can be operated at minimal tempering effort with variable controllable pulse rates in the range of typically 0 to 150 Hz, and at reduced pulse power with pulse rates of up to approximately 1 kHz.

The laser thus emits laser light with an average power of approximately 5 Watts (optical) at a typical total power consumption (including control, excluding external tempering) of 100 Watts (electrical). The emitted laser beam has a typical beam divergence <5 mrad at a beam diameter of typically ≦3 mm which depends on the diameter of the laser medium.

The passively wavelength stabilized laser diodes 22 are arranged in an annular way in a central recess of a suitable carrier ring 21 in the arrangement in accordance with the invention, similar to prior known arrangements, and jointly form a pump ring 2. The number of used laser diodes depends in each case on the overall size of the laser light source, the laser diodes 22 and the required pump output. In the configuration of the pump rings as shown here, preferably three to eight laser diodes are used per pump ring, e.g. six passively wavelength stabilized laser diodes 22 per pump ring 2.

In the case of a need for higher output it is possible and advantageous to switch several pump rings 2 behind one another by using a monolithic laser resonator 1 with a longer solid-state laser medium 11, as is shown in FIG. 1 by way of example for an arrangement with two pump rings. This leads to better efficiency and smaller overall sizes than the use of only one pump ring with a higher number of laser diodes, and simplifies tempering. The laser diodes of successively following pump rings are aligned to preferably form gaps in such arrangements. In the illustrated case with six laser diodes, the pump rings are thus twisted preferably against each other by 30° with respect to the main axis of the laser light source, as shown in FIG. 1 and FIG. 2.

In order to temper the laser light source, tempering ducts 41 are incorporated in the carrier rings 21 of the passively wavelength stabilized laser diodes 22. The shape and number of these tempering ducts is chosen according to the thermal output of the laser light source which is to be transferred at most. This leads to a tempering agent circulation together with ducts incorporated in the front end cap 31 and the rear end cap 32 of the laser light source and a flow tube 42 which is flowed through by the tempering agent and encloses the monolithic laser resonator.

The tempering agent circulation 4 is preferably connected to an external tempering unit for laser applications with high medium output, with the laser light source preferably being flowed through from the outside to the inside, i.e. the tempering agent flows at first through the tempering ducts 41 of the carrier rings 21 and then through the area between the monolithic laser resonator 1 and the flow tube 42. In this embodiment, the input and the output are separated and preferably arranged in the rear end cap 32.

External tempering can frequently be omitted for applications with lower output. Instead of the separate inputs and outputs, both end caps 31, 32 are arranged to connect the outside and inside circuit, the tempering agent circulation 4 is filled with a suitable tempering medium and is sealed. The occurring heat loss is conveyed from the inside to the outside by heat conduction and convection in the tempering agent circulation and dissipated via the surface of the laser light source to the ambient environment. Depending on the application, it may be advantageous to provide the outer surface of the laser light source with cooling ribs for enlarging the heat transmission surface and/or a fan, etc. for improving heat transmission.

In both operating modes, the use of passively wavelength stabilized laser diodes as pump light sources leads to a minimization in the need for tempering and to an increase in operational stability. The reliability of the laser emission is fully guaranteed even in the case of or during significant load changes, e.g. as a consequence of a change in the pulse rate or other changes in the thermal state.

The monolithic laser resonator 1 used in accordance with the invention consists of the actual laser medium 11 in which the pump energy is converted into laser energy, a saturable absorber (passive Q-switch, 12) which is rigidly connected with the same preferably by bonding at the molecular level (interface I), and two resonator mirrors 13, 14. Dielectric mirrors, especially preferably multi-layer dielectric ones, are used as resonator mirrors, preferably configured to the respective laser emission wavelength. They are applied directly to the end surfaces of the laser medium or the saturable absorber bonded thereto. The mirror on the emitting side 13 is arranged in a partly reflective way, with a reflection factor of 50% for example; the second mirror is highly reflective, with a typical reflection factor of >99% at the emission wavelength of the solid-state laser.

It is additionally possible and advantageous to geometrically adjust the two mirrored end surfaces 13, 14 of the monolithic laser resonator to laser operation. In addition to planar end surfaces, especially axially symmetrically curved, convex or concave surfaces are advantageous for specific applications in order to compensate the occurrence of temperature gradients and the ensuing thermal lenses, to influence the mode distribution in the laser or to condition the emitted beam for transfer to an external beam lens system.

For the described arrangement, the use of a cylindrical laser resonator 1 is especially advantageous both with respect to the compactness as well as the minimization of the required work for installation, fastening and adjustment. Cuboid arrangements with a quadrangular, square or other polygonal cross section are possible for special applications and can be realized. In such embodiments, it is advantageous to adjust to each other the shape, number and alignment of the surfaces of the polygonal cuboid and the number and arrangement of the laser diodes in the used pump ring.

As a result of the monolithic configuration of the laser resonator 1, the installation and the fastening in the laser light source is possible with a minimum of constructional effort, especially when using a monolithic laser resonator 1 which is arranged in a cylindrical way. Preferably, the monolithic laser resonator 1 is fixed with two fastening elements 33, 34 in the holding plates 31, 32, which fastening elements are arranged as clamping screws for example. For this purpose, neither adjusting elements are necessary, nor is it possible that the laser resonator 1 can become maladjusted by mechanical and/or thermal loads. In combination with the passively wavelength stabilized laser pump diodes 22, a reliable operation can thus be ensured even under rough application conditions.

The fastening elements 33, 34 of the laser resonator 1 can be arranged depending on the respective application. The possible embodiment shown in FIG. 1 and FIG. 2 which comprises an optically accessible high-reflective end mirror 14 allows injecting the residual laser energy transmitted by the mirror 14 into an optical fiber for example and the use of this signal for example for laser monitoring, trigger signal, etc. without having to install additional optical components into the useful beam path of the laser.

It is often advisable for increasing the efficiency to implement further measures for optimizing the injection efficiency of the pump light into the laser medium in addition to the use of passively wavelength stabilized laser diodes as pump light sources and a monolithic laser resonator, as are necessary in accordance with the invention. The use of an energy-collecting flow tube is proposed hereby in accordance with the invention, especially when using solid-state laser media of small diameter and with a respectively low injection efficiency.

Prior known flow tubes consist of a material which is transparent for the excitation wavelength such as glass, quartz glass or sapphire. In these arrangements, pump radiation which is not absorbed by the laser medium passes through the opposite wall of the flow tube and is subsequently converted in a non-used way into heat.

In order to remedy this, it is proposed in accordance with the invention to preferably provide the outside surface of the flow tube 42 with a coating 42a which reflects the excitation radiation back into the interior of the flow tube. This coating can optionally be a mirror coating made of gold or aluminum for example, or a coating with a diffusely reflective material, preferably on the basis of titanium oxide and/or calcium carbonate and/or barium sulfate or any other material which is highly reflective at the excitation wavelength and is insensitive to photolysis under the application conditions. In order to inject the pump radiation, transparent areas 42b have been left open in this coating, which areas are adjusted geometrically to the emission characteristics and the arrangement of the pump diodes 22 in the laser light source.

This arrangement ensures that the light radiated into the interior of the flow tube 42 is concentrated there, radiation losses are minimized and the laser efficiency is optimized. This allows compensating at least partly the lower geometric absorption profile when using solid-state laser media of smaller diameter and building compact laser light sources with high pulse output and favorable beam quality.

FIG. 6 and FIG. 7 shows an embodiment of the present invention which corresponds substantially to that of FIG. 2 and FIG. 3, with no flow tube being provided however. Accordingly, the insulating coolant in the circulation 4 directly flows about the laser resonator 1 and the laser diodes 22.

In summary, the presented arrangement enables, in comparison with prior known systems, the construction of exceptionally compact, reliable and low-maintenance pulsed laser light sources of high output and exceptional beam quality through the combination in accordance with the invention of using a monolithic laser resonator 1 in combination with passively wavelength stabilized laser pump diodes 22 and optionally the use of an energy-collecting flow tube 42.

1. A solid-state laser, comprising a resonator (1) With a monolithic structure consisting of a laser medium, on which a passive Q-switch (12) and at least one resonator mirror are directly formed, and comprising several laser diodes (22) which, as a pump medium, radiate into the resonator (1) from the side, wherein the monolithic resonator (1) is held at one end in a first holding plate (31) and is held at its other end in a second holding plate (32), and between the first and second holding plate (31, 32) at least one carrier ring (21) is mounted which carries several laser diodes (22) which are passively wavelength stabilized.

2. The solid-state laser according to claim 1, wherein the laser diodes (22) are wavelength-stabilized by an external reflection element.

3. The solid-state laser according to claim 2, wherein the external reflection element is arranged as a holographic grating.

4. The solid-state laser according to claim 1, wherein several carrier rings (21) are provided between the first and the second holding plate (31, 32).

5. The solid-state laser according to claim 1, wherein an uneven number of laser diodes (22) are arranged at even distances in each carrier ring (21).

6. The solid-state laser according to claim 1, wherein a number of at least three laser diodes (22) are arranged at regular intervals in each carrier ring (21).

7. The solid-state laser according to claim 1, wherein cooling ducts are provided which extend through the first and the second holding plate (31, 32) and through the at least one carrier ring (21).

8. The solid-state laser according to claim 1, wherein a jacket tube (42) is mounted in the first and in the second holding plate (31, 32), which tube encloses the resonator (1), and that a flow space for a liquid cooling medium is provided between the resonator (1) and the jacket tube (42).

9. The solid-state laser according to claim 8, wherein the jacket tube (42) is reflectively coated, with the reflective coating having windows in the area of the laser diodes (22).

10. The solid-state laser according to claim 1, wherein the space between the resonator (1) and the carrier rings (21) is filled with an insulating cooling medium.

11. The solid-state laser according to claim 1, wherein the laser diodes (22) on different carrier rings (21) can be triggered separately from one another.
